(19) United States
(12) Patent Application Publication
(10) Pub. No.: US 2006/0239609 A1
(43) Pub. Date: Oct. 26, 2006

(54) Methods and apparatuses to increase wavelength channels in a wavelength-division-multiplexing passive-optical-network

(76) Inventors: Wayne V. Sorin, Mountain View, CA (US); Byoung Yoon Kim, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/410,751

(22) Filed: Apr. 24, 2006

Related U.S. Application Data
(60) Provisional application No. 60/675,362, filed on Apr. 26, 2005.

(51) Int. Cl. G02B 6/28

(52) U.S. Cl. 385/24

(57) ABSTRACT

Various methods and apparatuses are described in which data transmission in two or more discrete wavelength bands are routed in the same transmission direction between a central office and a remote node in a wavelength-division-multiplexed passive-optical-network (WDM PON). The two or more discrete wavelength bands are separated by at least ten nanometers in wavelength spectrum. Further, each wavelength band contains two or more optical wavelength channels within that wavelength band.

### RELATED APPLICATIONS.

This application claims priority to U.S. Provisional Patent Application No. 60/675,362, entitled “METHODS AND APPARATUSES TO INCREASE WAVELENGTH CHANNELS IN A WAVELENGTH-DIVISION-MULTIPLEXING PASSIVE-OPTICAL-NETWORK,” filed Apr. 26, 2005.

### FIELD

Embodiments of this invention relate to wavelength-division-multiplexing passive-optical-networks.

### BACKGROUND

A conventional wavelength-division-multiplexing passive-optical-network (WDM-PON) performs bidirectional communication by using two different wavelength bands. For instance, a downstream signal may be transmitted from a central office to an optical network unit located at a subscriber's location through a first wavelength band, such as 1570-1620 nanometers (nm). An upstream signal may be transmitted from the optical network unit to the central office through a second wavelength band, such as 1450-1500 nm.

A set number of discrete optical communication channels exists in these established wavelength bands. For example, the first wavelength band may contain sixteen discrete optical communication channels to carry information from the central office to sixteen discrete subscribers. Similarly, the second wavelength band may contain sixteen discrete optical communication channels to carry information from the sixteen discrete subscribers to the central office.

### SUMMARY

Various methods and apparatuses are described in which data transmission in two or more discrete wavelength bands is routed in the same transmission direction between a central office and a remote node in a wavelength-division-multiplexed passive-optical-network (WDM PON). The two or more discrete wavelength bands are separated by at least ten nanometers in wavelength spectrum. Further, each wavelength band contains two or more optical wavelength channels within that wavelength band.

### BRIEF DESCRIPTION OF THE DRAWINGS

The present invention is illustrated by example and not limitation in the figures of the accompanying drawings, in which like references indicate similar elements and in which:

FIG. 1 illustrates a block diagram of an embodiment of a WDM PON that transmits multiple wavelength bands in the same direction on a common optical fiber in the WDM PON.

FIG. 2a illustrates a graph of an embodiment of a dense wavelength-division-multiplexed wavelength bands integrated with optical channels in the coarse wavelength-division-multiplexed wavelength bands.

FIG. 2b illustrates a graph of an embodiment of a dense WDM PON using multiple wavelength bands in both the upstream and downstream directions.

FIG. 3 illustrates a block diagram of an embodiment of a WDM PON that transmits multiple wavelength bands in the same direction on a common optical fiber in a WDM PON.

FIG. 4a illustrates a graph of an embodiment of a dense wavelength-division-multiplexed passive-optical-network that uses two wavelength bands in both the upstream and downstream directions.

FIG. 4b illustrates a graph of an embodiment of a dense WDM PON that uses four wavelength bands in both the upstream and downstream directions.

FIG. 5 illustrates a block diagram of an embodiment of a WDM PON using an electrical switch to multiplex an optical wavelength channel into multiple data channels for two or more end users.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific optical channels, named components, connections, etc., in order to provide a thorough understanding of the present design. It will be apparent, however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details may be varied from and still be contemplated to be within the spirit and scope of the present design.

The following drawings and text describe various example implementations to increase the number of wavelength channels available to communicate information in a WDM PON.

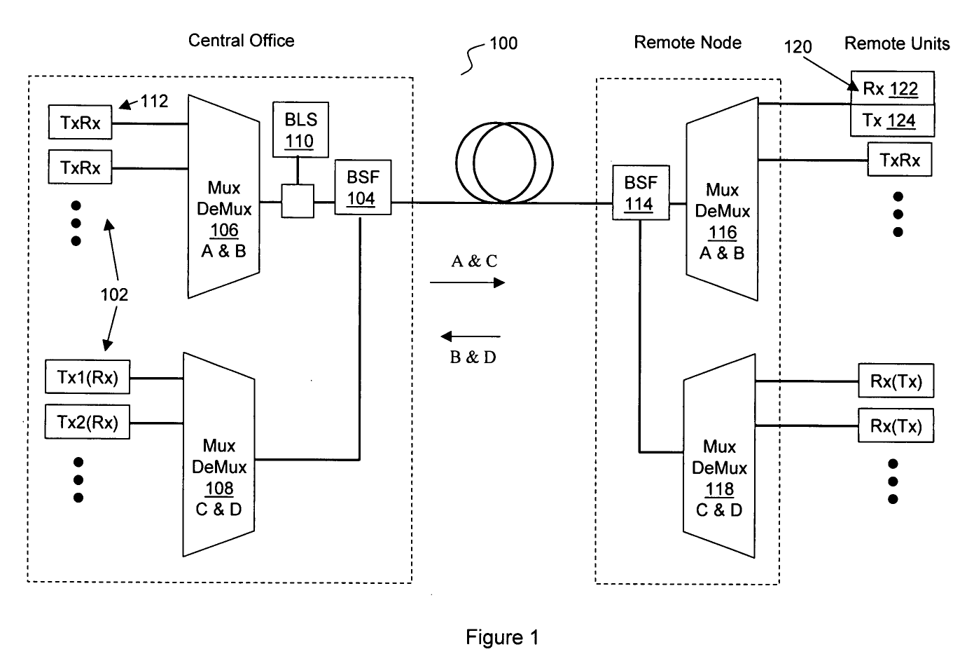

FIG. 1 illustrates a block diagram of an embodiment of a WDM PON that transmits multiple wavelength bands in the same direction on a common optical fiber in the WDM PON.

The WDM PON 100 may include a central office, a remote node, and a plurality of end user locations. The central office may contain a plurality of optical transmitters and optical receivers 102, a first band splitting filter 104, a first 1×N multiplexer/demultiplexer 106, a second 1×N multiplexer/demultiplexer 108, and a first broadband light source 110. N may be the number of subscriber potentially connected to that central office. Each optical transmitter in the central office, such as a first optical transmitter 112, may be a wavelength-specific light source such as a distributed feedback laser or a wavelength locked reflective optical modulator.

The remote node may have a second band splitting filter 114, a third 1×N multiplexer/demultiplexer 116, and a fourth 1×N multiplexer/demultiplexer 118. The third 1×N multiplexer/demultiplexer 116 and the fourth 1×N multiplexer/demultiplexer 118 each have a set of discrete end user locations associated with that multiplexer/demultiplexer. Each end user location may contain an optical network unit (ONU). Each ONU may include an optical receiver and a reflective modulator with an associated modulator and gain pump. For example, the first subscriber's location may contain a first ONU 120 with a first optical receiver 122, a first reflective modulator 124, such as wavelength-locked Fabry-Perot laser diode, a third band splitting filter, a first modulator, and a first gain pump. The third band splitting filter is configured to direct wavelengths in a first wavelength band originated from an optical transmitter in the central office to the first optical receiver 122. The third band splitting filter is also configured to direct wavelengths in a different wavelength band from the broadband light source 110 into the first reflective modulator 124. The first reflective modulator 124 reflects the injected light back out after the injected light signal has been modulated to carry any desired information from the subscriber to the central office. A reflective modulator may have a gain medium, such as the wavelength-locked Fabry-Perot laser diode, Reflective Semiconductor Optical Amplifier, etc. to amplify the injected light signal or may not have a gain medium such as a Lithium Niobate (LiNbO3) modulator using an electro-optic effect, a reflective cavity, etc.

One of the strong advantages for deploying a WDM-PON 100 as an access network is that the installed WDM-PON equipment can be upgraded over time to meet future higher bandwidth demands. One straight forward technique to upgrade bandwidth in the WDM PON 100 may be to simply increase the data rate supplied on each wavelength optical channel; however, existing transmitters and receivers may need to be replaced to achieve this increased bandwidth.

Another techniques may be to add additional optical channels on to the existing optical fibers and optic components making up the WDM-PON. For example, an already installed WDM PON 100 using optical channel wavelength bands established by Coarse WDM (CWDM) technology could be integrated and upgraded with optical equipment using optical channel wavelength bands established by Dense WDM (DWDM). Thus, additional wavelength channels are added to a previously installed WDM-PON possibly using a different WDM technology.

In FIG. 1, the equipment associated with the second multiplexer/demultiplexer 108 and the forth multiplexer/demultiplexer 118 add one or more additional wavelength bands to the previously installed WDM-PON system via their respective band splitting filters. The previously installed WDM-PON system utilized wavelength bands of A and B. The WDM PON 100 equipment using different wavelength bands of C and D may be integrated into the new WDM PON 100.

Thus, the first wavelength band (A), such as 1580 nm to 1610 nm, contains two or more wavelength channels and travels in a downstream direction. The second wavelength band (B), such as 1570 nm to 1540 nm, contains two or more wavelength channels and travels in an upstream direction. The addition of the first beam splitting filter allows a third wavelength band (C), such as 1480 nm to 1510 nm. The third wavelength band contains two or more wavelength channels and travels in the downstream direction on the common optical fiber 126 between the remote node and the central office. Similarly, the addition of the second beam splitting filter 114 allows the fourth wavelength band (D), such as 1470 nm to 1440 nm. The fourth wavelength band contains two or more wavelength channels and travels in the upstream direction with the second wavelength band on the common optical fiber 126 between the remote node and the central office.

The second band splitting filter 114 is configured to split the composite upstream optical signal that includes all of the wavelength channels in a first wavelength band and all of the wavelength channels in the third wavelength band onto two or more separate optical fibers. The first band splitting filter 104 is configured to split the composite downstream optical signal that includes all of the wavelength channels in a second wavelength band and all of the wavelength channels in the fourth wavelength band onto two or more separate optical fibers. In an alternate embodiment, the first band splitting filter 104 directs the additional coarse WDM optical channels from the downstream signal onto the optical fiber going to the second multiplexer/demultiplexer 108 and directs the optical channels in the A and B wavelength bands to the first multiplexer/demultiplexer 106.

The band splitting filters can be included in the initial implementation of the WDM-PON for the A and B wavelength bands or can be inserted at a later time when the extra wavelength bands are needed.

A band splitting filter can be constructed using thin-film dielectric filters or some other wavelength splitting technology. The insertion loss for a band splitting filter can be less than 0.5 dB so that the addition of these two elements can have a minimal effect on the overall link loss budget.

The band splitting filters may be included in the central office and the remote node. The band splitting filters could also be included at different locations, if necessary.

The first multiplexer/demultiplexer 106 that distributes wavelengths in the A & B wavelength bands may be constructed using thin-film dielectric filters but other devices such as array waveguide (AWG) filters could also be used.

The optical transmitters can be wavelength-locked reflective optical modulators, wavelength specific lasers, or a combination of wavelength-locked and wavelength-specific lasers.

The initial A & B wavelength bands can consist of sixteen optical wavelength channels each spaced at two hundred GHz, as in an example Fiber-To-The-Pole design, thirty two channels spaced at one hundred GHz as in an example Fiber To The Home design, or at some other unrelated channel number and channel spacing.

The data rates on the Dense WDM (DWDM) channels can all be the same or they can also be different even in the same direction. Thus, asymmetric data rates between downstream and upstream wavelength channels may exist. Moreover, asymmetric data rates between downstream signals in the first and the third wavelength bands may exist.

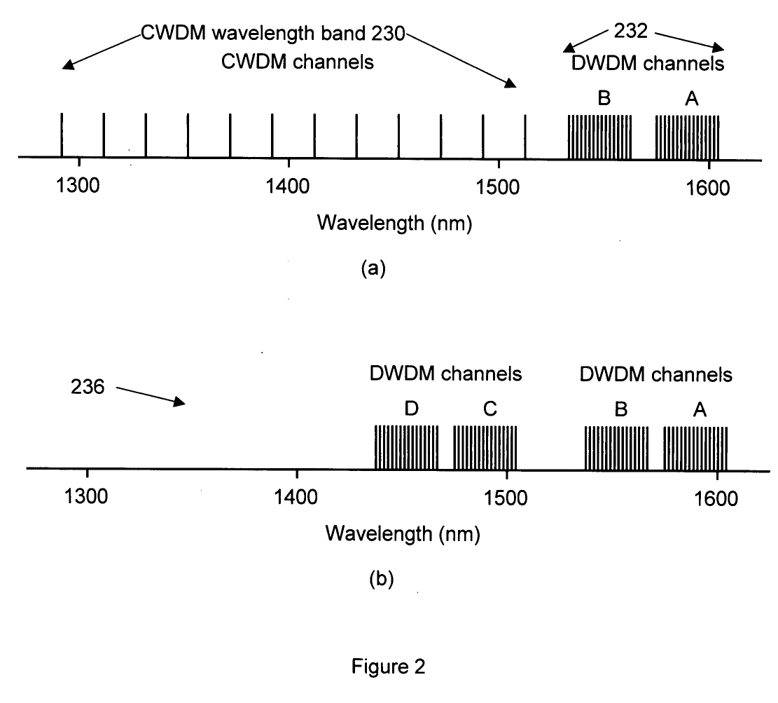

FIG. 2a illustrates a graph of an embodiment of a dense wavelength-division-multiplexed passive-optical-network integrated with optical channels in the coarse wavelength-division-multiplexed wavelength bands. One implementation could consist of using previously installed CWDM technology for the additional wavelength channels as shown in FIG. 2a. The optical channels using the CWDM technology would be in a CWDM wavelength band 230 starting centered at 1290 nm and ending centered at around 1510 nm. Thus, channel 1 starts around 1290 nm. Channel 12 is centered around 1510 nm. These channels would satisfy the ITU standard, which specifies a twenty nm spacing between upstream and downstream pairs of wavelength bands. The 12 additional CWDM channels in a CWDM wavelength band 230 could be added as shown in FIG. 2a assuming the DWDM bands 232 merely use wavelength above 1520 nm. Each CWDM optical channel would be wider and capable of more bandwidth than a DWDM optical channel. Thus, each CWDM optical channel could be used as a common channel to transmit very intensive bandwidth applications.

The direction of data flow along these channels could be set by customer demand with the number of upstream and downstream channels being different. For example, to address a large demand for one-way video services the extra CWDM channels could all be used for the downstream direction. Alternatively, half the CWDM channels could form a first CWDM wavelength band transmitted in the upstream direction and the other half could form a second CWDM wavelength band transmitted in the downstream direction. Data rates on each channel could also be different.

Wavelength-specific sources (for example, Distributed FeedBack lasers) could be used for each CWDM channel. The optical transmitters and optical receivers for the CWDM channels can be located at the same location as the DWDM channels or at different locations.

In the DWDM wavelength bands 232, the bandwidth of each wavelength band may be based upon the gain bandwidth/operating range bandwidth of the broadband light source for that wavelength band. For example, the wavelength band A may span twenty six nm, which corresponds to the gain bandwidth/operating range bandwidth of the broadband light source for that wavelength band. Within that twenty-six nm wavelength band, sixteen discrete optical channels exist.

FIG. 2b illustrates a graph of an embodiment of a dense wavelength-division-multiplexed passive-optical-network using multiple wavelength bands in both the upstream and downstream directions. The graph 236 illustrates the two upstream wavelength bands A and C and the two downstream wavelength bands B and D. The first wavelength band (A), such as 1580 nm to 1610 nm, contains an example sixteen optical channels. The second wavelength band (B), such as 1570 nm to 1540 nm, contains an example sixteen optical channels. The free spectral range between the upstream optical channel 1 in the A wavelength band and the downstream optical channel 1 in the B wavelength band may be an example forty nm. The addition of the beam splitting filters allows the additional multiplexers and transmitters to add a third wavelength band (C), such as 1480 nm to 1510 nm, that contains an example sixteen additional optical channels on the common optical fiber between the remote node and the central office. Similarly, the addition of the beam splitting filters allows the additional multiplexers and transmitters to also add a fourth wavelength band (D), such as 1470 nm to 1440 nm, that contains an example sixteen optical channels on the common optical fiber between the remote node and the central office.

Overall, the additional DWDM optical channels can be coupled through the beam splitting filters. The additional wavelength band(s) can have the same optical frequency (i.e. wavelength) span as bands A and B or they can be different. The transmitters for the C and D wavelength bands can consist of wavelength-specific lasers, reflective optical modulators, or some combination of the two. If reflective optical modulators having a gain medium are used then additional broadband light sources (BLS) may be added in front of the C & D multiplexer/demultiplexer in FIG. 1. These additional BLSs provide the input light signals across the range of the new wavelength band for all of the reflective optical modulators having a gain medium.

Also, upstream and downstream channel count and data rates can be symmetric or can be asymmetric.

Note, although not illustrated in FIG. 2b, more wavelength bands could also be added until the useful wavelength range of a single-mode fiber is exhausted. An example wavelength range for a single-mode fiber could be from 1250 nm to 1620 nm.

Overall, one or more additional wavelength bands can be added to a previously installed WDM-PON system by including band splitting filters to couple the additional wavelengths onto the common optical fiber between the central office and the remote node. The optical transmitters for each optical channel may be wavelength specific or wavelength locked to the wavelength of an injected light signal.

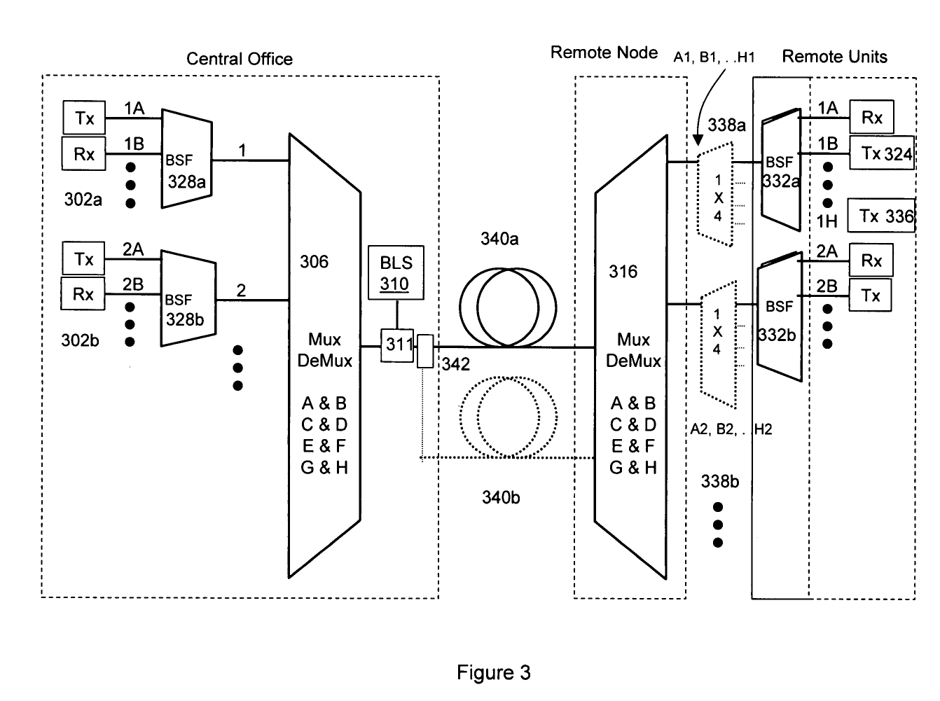

FIG. 3 illustrates a block diagram of an embodiment of a WDM PON that transmits multiple wavelength bands in the same direction on a common optical fiber in a WDM PON. The central office may include sets of optical transmitters and optical receivers 302a, 302b, a band splitting filter 328a, 328b connected to its associated set of optical transmitters and optical receivers 302a, 302b, a first multiplexer/demultiplexer 306, a broadband light source 310, and an optical coupler integrated with another splitting filter 311. The first remote node may contain a second multiplexer/demultiplexer 316.

The second multiplexer/demultiplexer 316 separates the combined wavelength bands into optical units having a smaller bandwidth of wavelengths, such as optical channels, on its output ports in the downstream direction. The second multiplexer/demultiplexer 316 also combines smaller optical units, such as optical channels, on its input ports in the upstream direction into combined wavelength bands. Note, additional multiplexer/demultiplexers may be inserted in the optical communication pathway between the second multiplexer and the eventual end users to increase the number of end users serviced by these optical units measured in wavelengths. For example, a second remote node with a multiplexer/demultiplexer 338a and a third remote node with a multiplexer/demultiplexer 338b may be added to distribute subsets of the optical channels contained within the composite upstream and downstream optical signals distributed by the second multiplexer/demultiplexer 316. Also, a destination remote node, such as a pole location in a neighborhood of end users, may contain a band splitting filter, such as a second band splitting filter 332a, to distribute the signal from the subset of optical channels servicing the end users in that neighborhood.

The second multiplexer/demultiplexer 316, such as an AWG (array waveguide) filter, may be configured to have a free spectral range so that at least one wavelength channel from all of the different wavelengths bands are present on the first output port of the second multiplexer/demultiplexer 316. This method takes advantage of the property that certain multiplexer/demultiplexer devices have a free-spectral-range (FSR) so that multiple wavelength bands are coupled into each optical fiber. In an embodiment, a multiplexer/demultiplexer may be constructed of thin filmed band splitting filters to route the multiple optical channel and not posses a free-spectral-range. The multiplexer/demultiplexer constructed of thin filmed band splitting filters is aligned such that one wavelength channel from all of the different wavelengths bands are present on the first output port of the multiplexer/demultiplexer.

Thus, the first output of the second multiplexer/demultiplexer 316 carries optical channel 1 of wavelength band A, optical channel 1 of wavelength band B, etc. up to optical channel 1 of wavelength band H. Likewise, the second output of the second multiplexer/demultiplexer 316 carries optical channel 2 of wavelength band A, optical channel 2 of wavelength band B, etc. up to optical channel 2 of wavelength band H.

A first optical transmitter may be a first reflective modulator 324 that has an input port to receive a first optical wavelength channel (1A) from the first wavelength band from the first output port of the second multiplexer/demultiplexer 316 via the second band splitting filter 332a to lock an output wavelength of the first reflective modulator 324 to within the bandwidth of the injected first optical wavelength channel (1A). A second reflective modulator 336 has an input port to receive a second optical wavelength channel (1H) from a second wavelength band from the first output port of the second multiplexer/demultiplexer 316 via the same second band splitting filter 332a. The band splitting filter in the destination remote node is separating out each optical channel from each wavelength band and distributes each optical channel to its associated end user.

Overall, the multiplexer/demultiplexer filters and separates the individual optical wavelength channels in each wavelength band to put one wavelength channel from each wavelength band on each output port of the multiplexer/demultiplexer. The band splitting filters in the other remote nodes separate out the repeating wavelength channels to route them to a corresponding end user. Additional remote nodes with multiplexer/demultiplexer and or band splitting filters to separate repeating wavelength bands may be added as shown by the 1×4 multiplexer/demultiplexer 338a, 338b with dotted lines. As system demand increases, both the data rates carried by a single optical channel may be increased as well as the number of optical channels by the above techniques.

In an alternative embodiment, both multiplexer/demultiplexers and band splitting filters may use a thin filmed band splitting filter to separate wavelength channels from different wavelength bands to two or more discrete users. The band splitting filters can be fiber pigtailed devices utilizing technologies such as dielectric thin-film filters. The band splitting filters can be included in the original system operation or can be inserted at a later time when the increased bandwidth is needed. The band splitting filters can be added to existing WDM-PON installations by inserting them in front of the transmitter-receiver pair modules when additional bandwidth is needed. They can be added independently at different wavelength channel locations on an as-needed-basis.

The insertion loss through a band splitting filter can be less than 0.5 dB so they can have a minimum effect on the system loss budget. One advantage of this approach is that no additional fibers or modifications are needed in the outside fiber plant, which can also be referred to as the optical distribution network.

Thus, the common optical fibers 340a, 340b between the central office and the first remote node can carry all of the multiple upstream and downstream wavelength bands. Accordingly, minor modifications may be required between the transmitter-receiver pairs 302a, 302b and the band splitting filters 332a, 332b to add channels to the existing system. Note, both the transmitter-receiver pairs 302a, 302b and the band splitting filters 332a, 332b are in locations that can be easily accessed. The added channels can use either wavelength-specific sources or wavelength-locked sources as the optical transmitter for that optical channel. As discussed previously, the wavelength-locked reflective modulators could have additional BSL sources incorporated in the BLS block 310.

As discussed the reflective modulators may have a gain medium such as a Fabry-Perot laser diode or no gain medium such as a Lithium Niobate (LiNbO3) modulator using an electro-optic effect. The bi-directional modules at each of the end user locations separate the two wavelengths between the reflective modulator and the optical receiver.

Data flow along each wavelength band or wavelength channel can be in either direction, depending on whether a port of the band splitting filter is connected to a transmitter or to a receiver. Data rates on the channels can be different or the same depending on the need.

A redundancy optical fiber 340b may be run between the central office and the remote node shown with dotted lines provides redundancy. The second multiplexer/demultiplexer 316 has a first input to receive a first common optical fiber 340a coupling a central office to a remote node. The second multiplexer/demultiplexer 316 has a second input to receive the redundant optical fiber 340b coupling the central office to the remote node to provide redundancy to carry the wavelength bands carried by the first optical fiber run between the central office and the remote node. The redundant optical fiber 340b is physically routed in a separate location and in a different bundle of fibers then the first optical fiber 340a. An optical switch 342 may be configured to cause the redundancy operation of carrying the wavelength bands between the central office and the remote node in the second optical fiber 340b upon detection of a failure associated with the first optical fiber 340a.

An optical time domain reflectometer may be used to detect faults such as breaks in the optical cables, such as the optical cables going between a remote node and the central office as well as the optical cables going between a remote node and each subscriber's location.

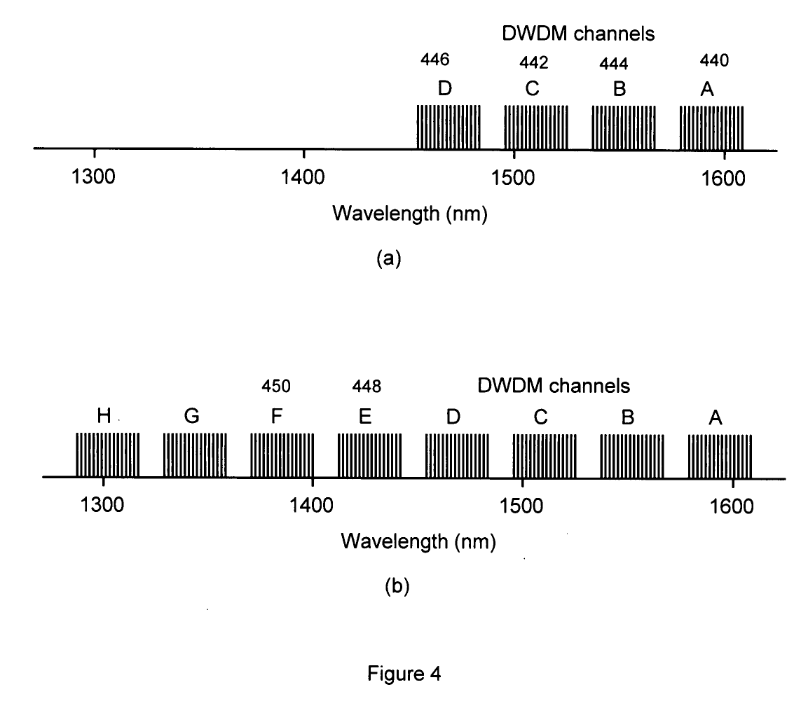

FIG. 4a illustrates a graph of an embodiment of a dense wavelength-division-multiplexed passive-optical-network that uses two wavelength bands in both the upstream and downstream directions. The graph illustrates the two upstream wavelength bands A and C 440, 442 and the two downstream wavelength bands B and D 444, 446. The first wavelength band (A) 440, such as 1580 nm to 1610 nm, contains an example sixteen optical channels. The second wavelength band (B) 444, such as 1570 nm to 1540 nm, contains an example sixteen optical channels. The free spectral range between the upstream optical channel 1 in the A wavelength band 440 and the downstream optical channel 1 in the B wavelength band 444 may be an example 40 nm. The first and second multiplexer/demultiplexers have been built to distribute wavelengths from approximately 1300 to 1620 nanometers. Thus, addition of transmitters and receivers and broadband light sources is generally all what is needed in the central office to add an additional third wavelength band 442 and a fourth wavelength band D 444.

The extra wavelength bands can be added in any sequence. For example, referring to FIGS. 4a and 4b, wavelength bands A and B 440, 444 could be used in the initial deployment, then wavelength bands C and D 442, 446 could be added later based on customer demand (see FIG. 4a), then wavelength bands E and F 448, 450 could be added even later (See FIG. 4b). Other examples implementations might be to include the necessary band splitting filters in the initial deployment so all wavelength bands (A-H) are designed in from the start (see FIG. 4b).

An example of a suitable multiplexer/demultiplexer could be an AWG with a FSR of about 5 Terahertz (˜40 nm), with a channel spacing of 100 GHz (˜0.8 nm). Thus, a free spectral range of approximately 40 nanometers exists between the first wavelength channel in wavelength band A and the second wavelength channel in wavelength band B. Each band could then have as many as 50 wavelength channels before the band repeats itself.

This design may be configured to have a channel spacing of 200 GHz (˜1.6 nm), which allows about 16 channels to be used (this example is illustrated in FIGS. 4a and 4b). 16 channels have been used as an example number of optical channels in the wavelength bands. The number of useable channels per band depends on the characteristics of the AWG and the required guard bands set by the band splitting filters. However, other examples of channel spacing could be values such as 25 GHz, 50 GHz or 400 GHz and different band spacings (i.e. different FSRs) can also be used. For example, 64 channels may be used to carry data in a wavelength band by narrowing the wavelength spacing between each optical channel to approximately 0.4 nm.

Channels not used to carry data may provide a guard band that is needed for the imperfect filtering characteristics of the band splitting filters.

Overall, the WDM-PON uses one or more multiplexer/demultiplexers capable of coupling multiple wavelength bands into the same optical fiber. The WDM-PON may have asymmetrical combinations of data rates, directions of data flow, and the use of wavelength-locked and wavelength-specific light sources.

The central office to the remote nodes can be connected by a single common fiber as in an example Fiber To The Home design or by two or more fibers as in an example Fiber-To-The-Pole design.

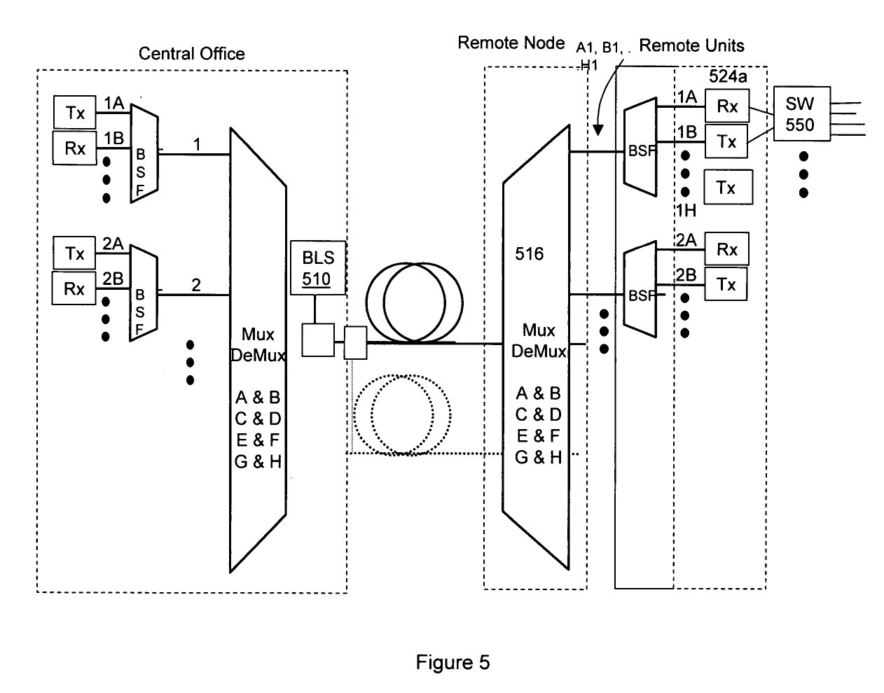

FIG. 5 illustrates a block diagram of an embodiment of a WDM PON using an electrical switch to multiplex an optical wavelength channel into multiple data channels for two or more end users. The second multiplexer/demultiplexer 516 couples an optical wavelength channel to each optical receiver and transmitter pair, such as a first optical receiver and transmitter pair 524a. The first optical receiver and transmitter pair 524a connect to an electrical switch 550, such as a fast Ethernet switch, a Gigabit-Ethernet switch, Digital Subscriber Line Access Multiplexer, or similar switch, that multiplexes an optical wavelength channel into multiple data channels for two or more end users. For example, a fast Ethernet switch 550 located at each destination remote node in a neighborhood may be used to couple a single downstream receiver and transmitter pair 524a to provide data channels for two or more end users. Thus, communications, for example, of three hundred and eighty four discrete subscribers may be carried on the single common optical fiber between the central office and the first remote node. After both the first remote node separates the optical channel and any additional remotes nodes between the first remote node and the destination remote node separate and distribute optical channels in different wavelength bands, one optical channel may be supplied to a fast Ethernet switch 550 located on a pole. The fast Ethernet switch 550 may convert the single optical signal to a digital signal. The fast Ethernet switch 550 may then supply and address, for example, 24 different subscribers by itself. Each subscriber receiving a maximum transmission capacity, such as 100 megabits, of a 1-gigabit capacity optical channel.

An Erbium doped fiber amplifier may be used as a broadband light source 510 for two or more wavelength bands such as wavelength bands A and B. A supplemental broadband light source (not shown), such as a super luminescent diode, may be used as the source for the additional wavelength bands. Both of the broadband light sources act as the source of injection wavelengths for the reflective modulators.

In the forgoing specification, the invention has been described with reference to specific exemplary embodiments thereof. It will, however, be evident that various modifications and changes may be made thereto without departing from the broader spirit and scope of the invention as set fourth in the appended claims. The specification and drawings are, accordingly, to be regarded in an illustration rather than a restrictive sense.
What is claimed is:

1. An apparatus, comprising:
a first multiplexer/demultiplexer in a wavelength-division-multiplexed passive-optical-network (WDM PON) having first plurality of input ports to receive a plurality of optical wavelength channels in a first wavelength band, a second plurality of input ports to receive a plurality of optical wavelength channels in a second wavelength band, and an output port to route data transmission in the first wavelength band and data transmission in the second wavelength band in the same transmission direction, where the wavelength bands will be separated by at least ten nanometers in wavelength spectrum.

2. The apparatus of claim 1, further comprising:
a second multiplexer/demultiplexer configured to have a free spectral range so that at least one optical wavelength channel from both of the first wavelength band and the second wavelength band are present on the second output port of the second multiplexer/demultiplexer; and
an optical fiber between the first multiplexer/demultiplexer and the second multiplexer/demultiplexer to carry the first wavelength band and the second wavelength band.

3. The apparatus of claim 2, further comprising:
a first reflective modulator having a first input port to receive a first optical wavelength channel from a first wavelength band from the first output port of the second multiplexer/demultiplexer via a band splitting filter; and
a second reflective modulator having a second input port to receive a second optical wavelength channel from a second wavelength band from the first output port of the second multiplexer/demultiplexer via the same band splitting filter.

4. The apparatus of claim 3, wherein the first reflective modulator includes a Fabry Perot laser diode.

5. The apparatus of claim 3, wherein the first reflective modulator includes a Reflective Semiconductor Optical Amplifier.

6. The apparatus of claim 2, wherein the second multiplexer/demultiplexer to spectrally slice the first wavelength band into optical channels and a first reflective modulator has a first port to receive a first optical wavelength channel from the first wavelength band from the first output port of the second multiplexer/demultiplexer via a filter to lock an output wavelength of the first reflective modulator to within the bandwidth of the injected first optical wavelength channel.

7. The apparatus of claim 3, wherein a first optical transmitter to optically transmit a first signal at a first data rate to the first multiplexer/demultiplexer, where the first multiplexer/demultiplexer to create a combined downstream signal that includes the first signal and a second optical transmitter to transmit a second signal at a second data rate asymmetric with the first data rate.

8. The apparatus of claim 3, wherein the first multiplexer/demultiplexer having a plurality of input ports to receive optical signal inputs from the first wavelength band and the second wavelength band and to route a downstream signal that combines the first wavelength band and the second wavelength band, wherein the generated downstream signal has an asymmetric number of optical channels within the downstream signal than a number of optical channels in the upstream signal.

9. The apparatus of claim 2, wherein the second multiplexer/demultiplexer has a first input to receive a first optical fiber coupling a central office to a remote node and a second input to receive a second optical fiber coupling the central office to the remote node to provide redundancy to carry the wavelength bands carried by the first optical fiber run between the central office and the remote node, wherein the second optical fiber is physically routed in a separate location and in a different bundle of fibers then the first optical fiber; and
a switch configured to cause a redundancy operation of carrying the wavelength bands between the central office and the remote node in the second optical fiber upon detection of a failure associated with the first optical fiber.

10. The apparatus of claim 2, wherein the second multiplexer/demultiplexer to couple a first optical wavelength channel to a first optical receiver and transmitter pair, wherein the first optical receiver and transmitter pair to connect to an electrical switch that multiplexes the first optical wavelength channel into data channels for two or more end users.

11. The apparatus of claim 2, further comprising:
a band splitting filter optically coupled to the first multiplexer/demultiplexer to receive and route the data transmission in the first wavelength band and the data transmission in the second wavelength band traveling in the same transmission direction to the optical fiber; wherein the band splitting filter to also receive and route data transmission in a third wavelength band traveling in an opposite transmission direction than the first wavelength band and the second wavelength travel.

12. The apparatus of claim 3, wherein the first reflective modulator includes a Lithium Niobate modulator using an electro-optic effect.

13. A system, comprising:
a first plurality of optical transmitters to each transmit a different optical wavelength channel to a first multiplexer/demultiplexer, wherein the different optical wavelength channels from the first plurality of optical transmitters are combined to form a first wavelength band on a first output of the first multiplexer/demultiplexer;
a second plurality of optical transmitters to each transmit a different optical wavelength channel to a second multiplexer/demultiplexer, wherein the different optical wavelength channels from the second plurality of optical transmitters are combined to form a second wavelength band on a second output of the second multiplexer/demultiplexer; and
a first band splitting filter coupled to the first multiplexer/demultiplexer and the second multiplexer/demultiplexer to combine data transmission in the first wavelength band and data transmission in the second wavelength band to travel in a same transmission direction.

14. The system of claim 13, further comprising:
a third plurality of optical transmitters to each transmit a different optical wavelength channel to the second multiplexer/demultiplexer, wherein the different optical wavelength channels from the third plurality of optical transmitters are combined to form a third wavelength band on the second output of the second multiplexer/demultiplexer, wherein the first band splitting filter to combine data transmission in the first wavelength band, the second wavelength, and the third wavelength band to travel in a same transmission direction.

15. The system of claim 13, further comprising:
a second band splitting filter, a third multiplexer/demultiplexer, and a fourth multiplexer/demultiplexer, wherein the second band splitting filter is configured to direct wavelengths in the first wavelength band to the third multiplexer/demultiplexer and wavelengths in the second wavelength band to the fourth multiplexer/demultiplexer.

16. The system of claim 13, wherein the third multiplexer/demultiplexer to spectrally slice the first band of wavelengths into optical wavelength channels; and
a first reflective modulator has a first port to receive a first optical wavelength channel from the first wavelength band from the first output port of the second multiplexer/demultiplexer via a filter to lock an output wavelength of the first optical transmitter to within the bandwidth of the injected first optical wavelength channel.

17. The system of claim 16, wherein the first reflective modulator is included in an optical network unit that also includes an optical receiver, an associated modulator, and a gain pump.

18. The system of claim 13, wherein the third multiplexer/demultiplexer has a first output port to send a first optical wavelength channel from the first wavelength band and a second optical wavelength channel from the second wavelength band to a thin-filmed band splitting filter, wherein the thin-filmed band splitting filter to separate optical wavelength channels from the different wavelength bands to two or more discrete users.

19. The system of claim 13, wherein the first plurality of optical transmitters to transmit wavelengths in the dense wavelength-division-multiplexed optical spectrum having optical wavelength channel spacing less than five nanometers apart and the second plurality of optical transmitters to transmit wavelengths in the coarse wavelength-division-multiplexed optical spectrum having optical wavelength channel spacing greater than fifteen nanometers apart.

20. A method, comprising:
routing between a central office and a remote node in a wavelength-division-multiplexed passive-optical-network (WDM PON) data transmission in two or more discrete wavelength bands in the same transmission direction, where each wavelength band contains two or more optical wavelength channels within that wavelength band and each wavelength band is separated by at least ten nanometers in wavelength spectrum.

21. The method of claim 20, further comprising:
receiving an optical wavelength channel from a first band of wavelengths; and
locking an output wavelength of the first optical transmitter to within the bandwidth of the injected optical wavelength channel.

22. The method of claim 21, further comprising:
converting data in the optical wavelength channel into electrical signals;
multiplexing the data from the optical wavelength channel into multiple discrete data channels;
routing a first data channel in electrical form to a first user; and
routing a second data channel in electrical form to a second user.

23. The method of claim 21, further comprising:
routing data transmission in three or more discrete wavelength bands in the same transmission direction between the central office and the remote node in the wavelength-division-multiplexed passive-optical-network (WDM PON).
